(19) United States
(12) Patent Application Publication
(10) Pub. No.: US 2019/0228929 A1
(43) Pub. Date: Jul. 25, 2019

(54) SOFT-RUBBER KEYBOARD HAVING HARD SHEETS WITH CONVEX SWITCHES

(71) Applicant: Haibo JIANG, SHENZHEN (CN)

(72) Inventor: Haibo JIANG, SHENZHEN (CN)

(21) Appl. No.: 16/257,924

(22) Filed: Jan. 25, 2019

Related U.S. Application Data
(63) Continuation of application No. PCT/CN2017/095357, filed on Aug. 1, 2017.

(30) Foreign Application Priority Data
Oct. 19, 2016 (CN) 201621140578.8

(51) Int. Cl. H01H 13/704; H01H 13/88

(52) U.S. Cl. CPC H01H 13/704; H01H 13/88; H01H 2209/026; H01H 2209/074; H01H 2229/048

(57) ABSTRACT

A soft-rubber keyboard having hard sheets with convex switches includes: a printed circuit film, a keyboard base plate for supporting the printed circuit film, an integrated soft-rubber keycap and a plurality of hard sheets. The integrated soft-rubber keycap includes a plurality of key units. The key unit is formed by connecting a soft-rubber key surface, a soft-rubber supporting body and a soft-rubber key base. Each key unit corresponds to one hard sheet. A convex switch body is downwardly integrated with the center of the hard sheet. The hard sheet is bonded to via an adhesive or integrally formed by injection molding with the bottom surface of the soft-rubber key surface. The convex switch body in the center of the hard sheet corresponds to a circuit switching point of the printed circuit film. The soft-rubber keyboard has the characteristics of simple processing, low cost, simple assembling and good press stability.

### CROSS-REFERENCE TO RELATED APPLICATIONS

This application is a continuation of International Patent Application No. PCT/CN2017/095357 with a filing date of Aug. 1, 2017, designating the United States, now pending, and further claims priority to Chinese Patent Application No. 201621140578.8 with a filing date of Oct. 19, 2016. The content of the aforementioned applications, including any intervening amendments thereto, are incorporated herein by reference.

### TECHNICAL FIELD

The disclosure relates to the technical field of computer keyboards, and particularly relates to a soft-rubber keyboard having hard sheets with convex switches.

### BACKGROUND OF THE PRESENT INVENTION

In the current soft-rubber keyboard without scissor feet, hard sheets are provided on the bottom surface of the key surface of a soft key to improve the strength and the flatness of the key surface. In the previous design mechanism, a convex switch body is integrally and downwardly molded on the key surface of the soft key in order to reduce independent soft rubber switches, and the convex switch body penetrates through a through hole by trepanning on the hard sheet and then corresponds to a circuit switching point on a printed circuit film. When injected molded soft keys of this structure are pressed, there is a need for an injection molding structure of a special downwardly convex switch body and to trepan on the hard sheet. Furthermore, when assembling, a perforating bonding or integral molding process is adopted, and the assembling and producing structure is troublesome. How to further optimize the existing structure to achieve the same functions to save cost and manpower becomes an urgent problem.

### SUMMARY OF PRESENT INVENTION

It is an objective of the present disclosure to provide a soft-rubber keyboard having hard sheets with convex switches, which is simple to process, low in cost, simple in assembling and good in press stability.

In order to achieve the above objective, the technical solution of the present disclosure is as follows: provided is a soft-rubber keyboard having hard sheets with convex switches, including a printed circuit film, a keyboard base plate for supporting the printed circuit film, an integrated soft-rubber keycap and a plurality of hard sheets, the integrated soft-rubber keycap includes a plurality of key units; the key unit is formed by connecting a soft-rubber key surface, a soft-rubber supporting body and a soft-rubber key base; each key unit corresponds to one hard sheet; a convex switch body is downwardly and integrated with the center of the hard sheet; the hard sheet is bonded to a bottom surface of the soft-rubber key surface by an adhesive or integrally formed with the soft-rubber key surface by injection molding; the convex switch body in the center of the hard sheet corresponds to a circuit switching point of the printed circuit film.

The convex switch body is a hemisphere or a cylinder-shaped body integrally formed by injection molding, and a spherical surface of the convex switch body right corresponds to the switching point of the printed circuit film.

An upper end and a lower end of the soft-rubber supporting body are respectively connected with the soft-rubber key surface and the key base to form an integrated “I”-shaped soft rubber body.

The soft-rubber key base is bonded to the corresponding printed circuit film.

The hard sheet is a hard plastic sheet, a metal sheet, or a glass sheet.

The hard sheet is a hard grid sheet.

The hard sheet is a pore-free solid hard sheet.

The integrated soft-rubber keycap adopts a soft rubber material such as silica gel rubber, TPP rubber, or PVC rubber.

The integrated soft-rubber keycap is made of a transparent rubber material.

A groove whose size and shape are matched with those of the hard sheet is formed on the bottom surface of the soft-rubber key surface; when assembling, the hard sheet is formed in the groove by bonding or integral injection molding.

After the above structure and the method are adopted, the present disclosure has the following advantages that:

1. The soft-rubber key surface does not need a downwardly molded switch body, thereby optimizing a structure of a mold and reducing requirements on an injection molding process, so that production is more convenient;

2. A convex switch body is downwardly integrated with the center of the hard sheet, when assembling, the hard sheet is formed on the surface of the soft rubber key by means of direct bonding or integral injection molding, and thus assembling is simple and the previous perforating assembly structure is not needed;

3. The hard sheet can allow the soft-rubber key surface to be evenly and steadily pressed and stressed;

4. Since there is no need for scissor feet and independent elastic silica gel switch components, components are few, cost is low, and assembling is simple and convenient.

### DESCRIPTION OF THE DRAWINGS

FIG. 1 is a schematic diagram of a cross-sectional structure of a keyboard according to embodiment 1 of the present disclosure;

FIG. 2 is an exploded view of a stereoscopic structure of a key unit according to embodiment 1 of the present disclosure;

FIG. 3 is a schematic diagram of a local cross-sectional structure of a key unit embodiment 2 of the present disclosure.

### DETAILED DESCRIPTION OF PREFERRED EMBODIMENTS

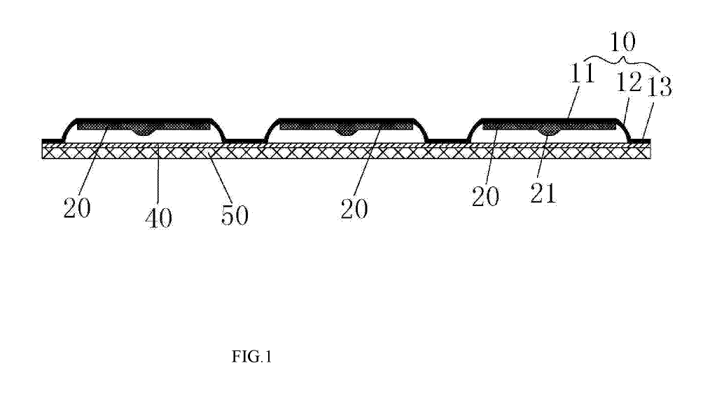

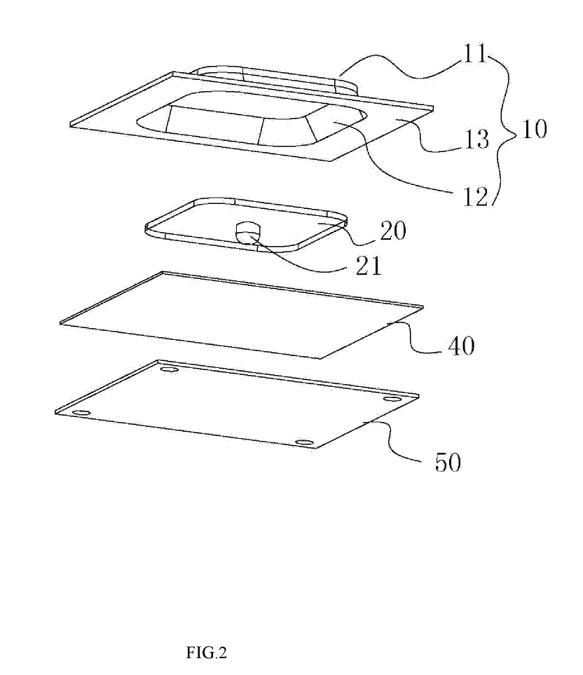

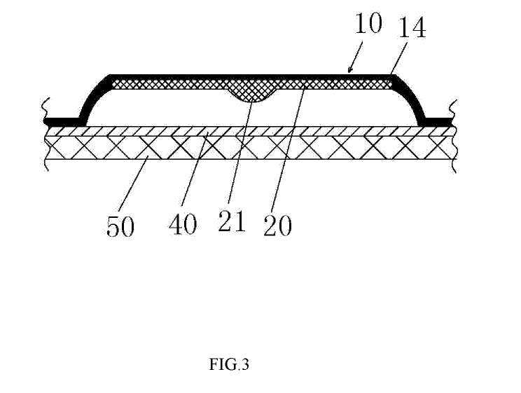

As shown in FIGS. 1-3, a soft-rubber keyboard having hard sheets with convex switches, includes a printed circuit film 40, a keyboard base plate 50 for supporting the printed circuit film 40, an integrated soft-rubber keycap 10 and a plurality of hard sheets 20. The integrated soft-rubber keycap 10 includes a plurality of key units; the key unit is formed by connecting a soft-rubber key surface 11, a soft-rubber supporting body 12 and a soft-rubber key base 13. Each key unit corresponds to one hard sheet 20; a convex switch body 21 is downwardly integrated with the center of the hard sheet 20; the hard sheet 20 is bonded to the bottom surface of the soft-rubber key surface 11 by an adhesive or integrally formed with the soft-rubber key surface 11 by injection molding; the convex switch body 21 in the center of the hard sheet 20 corresponds to a circuit switching point of the printed circuit film 40.

The convex switch body 21 is a hemisphere or a cylinder-shaped body integrally formed by injection molding, and a spherical surface of the convex switch body right corresponds to the switching point of the printed circuit film 40.

An upper end and a lower end of the soft-rubber supporting body 12 are respectively connected with the soft-rubber key surface 11 and the key base 13 to form an integrated “I”-shaped soft rubber body, in such a way, a gap between soft-rubber key surfaces 11 of the adjacent key units can be narrowed according to design demands, so that the whole key surface of the product is extremely smooth.

The soft-rubber key base 13 is bonded to the corresponding printed circuit film 40.

The material of the hard sheet 20 is a hard plastic sheet, a metal sheet, or a glass sheet.

The structure of the hard sheet 20 is a hard grid sheet or a pore-free solid hard sheet.

The integrated soft-rubber keycap 10 adopts a soft rubber material such as silica gel rubber, TPP rubber, or PVC rubber.

The integrated soft-rubber keycap 10 is made of a transparent rubber material.

A groove 14 whose size and shape are matched with those of the hard sheet 20 is formed on the bottom surface of the soft-rubber key surface; when assembling, the hard sheet 20 is formed in the groove 14 by bonding or integral injection molding.

When in use, the soft-rubber key surface 11 downwardly and vertically moves along with downward bending of the soft-rubber supporting body 13 when a finger presses the soft-rubber key surface 11, the hard sheet 20 integrally connected with the bottom surface of the soft-rubber key surface 11 synchronously, downwardly and vertically moves as well, and meanwhile, the convex switch body 21 in the center of the hard sheet 20 downwardly and vertically moves until clicking and contacting the circuit switching point corresponding to the printed circuit film 20 so that the circuit is closed and powered on.

When the finger leaves the soft-rubber key surface 11, the deformation of the soft-rubber supporting body 13 is recovered, the convex switch body 21 in the center of the hard sheet 20 is separated from the circuit switching point corresponding to the printed circuit film 20 to disconnect the circuit, and the integrated soft-rubber keycap 10 is recovered to an initial state.

In such a way, the present disclosure has the characteristics of simple processing, low cost, simple assembling and good press stability.

We claim:

1. A soft-rubber keyboard having hard sheets with convex switches, comprising: a printed circuit film, a keyboard base plate for supporting the printed circuit film, an integrated soft-rubber keycap and a plurality of hard sheets, wherein, the integrated soft-rubber keycap comprises a plurality of key units; each of the key units is formed by connecting a soft-rubber key surface, a soft-rubber supporting body and a soft-rubber key base; each key unit corresponds to one hard sheet; a convex switch body is downwardly integrated with a center of the hard sheet; the hard sheet is bonded to a bottom surface of the soft-rubber key surface by an adhesive or integrally formed with the soft-rubber key surface by injection molding; the convex switch body in the center of the hard sheet corresponds to a circuit switching point of the printed circuit film.

2. The soft-rubber keyboard according to claim 1, wherein, the convex switch body is a hemisphere or a cylinder-shaped body integrally formed by injection molding, and a spherical surface of the convex switch body right corresponds to the switching point of the printed circuit film.

3. The soft-rubber keyboard according to claim 1, wherein, an upper end and a lower end of the soft-rubber supporting body are respectively connected with the soft-rubber key surface and the key base to form an integrated “I”-shaped soft rubber body.

4. The soft-rubber keyboard according to claim 1, wherein, the soft-rubber key base is bonded to the printed circuit film correspondingly.

5. The soft-rubber keyboard according to claim 1, wherein, the hard sheet is a hard plastic sheet, a metal sheet, or a glass sheet.

6. The soft-rubber keyboard according to claim 1, wherein, the hard sheet is a hard grid sheet.

7. The soft-rubber keyboard according to claim 1, wherein, the hard sheet is a pore-free solid hard sheet.

8. The soft-rubber keyboard according to claim 1, wherein, the integrated soft-rubber keycap adopts a soft rubber material including silica gel rubber, TPP rubber, or PVC rubber.

9. The soft-rubber keyboard according to claim 1, wherein, the integrated soft-rubber keycap is made of a transparent rubber material.

10. The soft-rubber keyboard according to claim 1, wherein, a groove whose size and shape are matched with those of the hard sheet is molded on the bottom surface of the soft-rubber key surface; when assembling, the hard sheet is formed in the groove by bonding or integral injection molding.
